(19) United States
(12) Patent Application Publication
(10) Pub. No.: US 2024/0142110 A1
(43) Pub. Date: May 2, 2024

(54) INDUCTION HOB

(71) Applicant: Miele & Cie. KG, Guetersloh (DE)

(72) Inventors: Meike GARBEN, Roedinghausen (DE); Frank HOLTMANN, Hiddenhausen (DE); Alexander AUELL, Bielefeld (DE); Lukas Henry KRAEMER, Bielefeld (DE)

(21) Appl. No.: 18/497,016

(22) Filed: Oct. 30, 2023

(30) Foreign Application Priority Data
Nov. 2, 2022 (DE) 10 2022 128 987.7

(51) Int. Cl. F24C 15/00; H05B 6/12

(52) U.S. Cl. CPC F24C 15/006; H05B 6/1209

(57) ABSTRACT

A induction hob includes: a top surface with at least one cooking zone; a holding plate arranged in parallel with the top surface; at least one inductive heating coil arranged in an intermediate space between the top surface and the holding plate; at least one electronics housing with electronics for the heating coil, which electronics housing is arranged on a side of the holding plate facing away from the heating coil; a bottom box delimiting the induction hob at the bottom, the electronics housing including the electronics being arranged in the bottom box, which is open at a top thereof, and the holding plate covering the bottom box in a substantially airtight manner at the top; and at least one fan by which a cooling air flow for cooling the electronics is generatable in the bottom box.

### CROSS-REFERENCE TO PRIOR APPLICATION

Priority is claimed to German Patent Application No. DE 10 2022 128 987.7, filed on Nov. 2, 2022, the entire disclosure of which is hereby incorporated by reference herein.

### FIELD

The invention relates to an induction hob of the type mentioned herein.

### BACKGROUND

Such induction hobs are already known from the prior art in a plurality of different embodiments and comprise a top surface with at least one cooking zone, a holding plate, at least one inductive heating coil arranged in an intermediate space between the top surface and the holding plate, at least one electronics housing with electronics for the heating coil, which electronics housing is arranged on a side of the holding plate facing away from the heating coil, and a bottom box which delimits the induction hob at the bottom, wherein the electronics housing comprising the electronics is arranged in the bottom box which is open at the top and the holding plate covers the bottom box in a substantially airtight manner at the top, and wherein the induction hob has at least one fan, by means of which a cooling air flow for cooling the electronics can be generated in the bottom box.

By way of example, reference is made herein to DE 10 2020 121 633 A1 and DE 10 2012 219 040 A1 for the existing prior art.

### SUMMARY

In an embodiment, the present invention provides an induction hob, comprising: a top surface with at least one cooking zone; a holding plate arranged in parallel with the top surface; at least one inductive heating coil arranged in an intermediate space between the top surface and the holding plate; at least one electronics housing with electronics for the heating coil, which electronics housing is arranged on a side of the holding plate facing away from the heating coil; a bottom box delimiting the induction hob at the bottom, the electronics housing comprising the electronics being arranged in the bottom box, which is open at a top thereof, and the holding plate covering the bottom box in a substantially airtight manner at the top; and at least one fan by which a cooling air flow for cooling the electronics is generatable in the bottom box, wherein at least one air chamber is arranged between the bottom box comprising the electronics on one side and the holding plate on an other side, the at least one air chamber extending in parallel with the holding plate and substantially over an entire clear surface area of the bottom box and being substantially hermetically sealed relative to a permeable remainder of the induction hob.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows an embodiment of the induction hob according to the invention in a partial front view,

FIG. 2 shows the embodiment in a first partial cut side view, and

FIG. 3 shows the embodiment in a second partial cut side view.

### DETAILED DESCRIPTION

In an embodiment, the present invention addresses the problem of improving an induction hob.

In an embodiment, the present invention provides an induction hob as described herein, wherein at least one air chamber is arranged between the bottom box comprising the electronics on one side and the holding plate on the other side, wherein the air chamber extends in parallel with the holding plate and substantially over the entire clear surface area of the bottom box and is substantially hermetically sealed relative to a permeable remainder of the induction hob.

The advantage achievable by the invention is in particular that an induction hob is improved. Due to the design of the induction hob according to the invention, temperature management in the induction hob is substantially improved in a structurally simple manner, for example without complicated and thus expensive thermal insulation or cooling. This applies in particular to induction hobs intended for the North American market, i.e., for the USA or Canada, since the bottom box of such induction hobs must be designed as a plastics drip tray. In case of fire, this plastics drip tray is intended to receive molten plastics so that it cannot flow out of the induction hob. Such a bottom box makes the above-mentioned temperature management in these induction hobs even more difficult. The general installation situation of induction hobs in a closed base cabinet of a piece of kitchen furniture is also a hindrance to temperature management. The invention provides a remedy here. Furthermore, the thermal insulations used in the prior art, which are usually made of glass fiber materials, are more difficult to handle during installation due to personnel safety measures.

In principle, the type, mode of operation, dimensions, material and arrangement of the induction hob according to the invention are freely selectable within a suitable wide range. For example, the induction hob according to the invention may be designed as a household hob or as a commercial hob, i.e., as an induction hob for professional use.

An advantageous development of the induction hob according to the invention provides that the at least one air chamber is substantially hermetically sealed by means of at least one intermediate plate, preferably additionally by means of the holding plate, from the permeable remainder of the induction hob. In this way, the at least one air chamber can be designed and produced in a particularly simple manner. This applies in particular to the preferred embodiment of this development.

Another advantageous development of the induction hob according to the invention provides that the at least one air chamber is designed as two air chambers which are separate from one another, preferably that the two air chambers are arranged perpendicularly to the holding plate in immediate succession between the bottom box on one side and the holding plate on the other side, preferably that the two air chambers are formed by means of a first intermediate plate fastened to the bottom box, a second intermediate plate, all the edges of which are bent and which is placed on the first intermediate plate, and the holding plate. This further improves thermal decoupling, i.e., insulation, of the bottom box comprising the electronics on one side and the intermediate space comprising the at least one inductive heating coil. The preferred embodiment of this development moreover has the additional advantage that the two air chambers are particularly simple to design and produce. This applies in particular to the preferred embodiment of this development.

An advantageous development of the induction hob according to the invention provides that the bottom box has at least one intake pipe for ambient air on an underside facing away from the holding plate, preferably that the at least one intake pipe is assigned to a fan in each case. In this way, active cooling of the bottom box comprising the electronics housing and the electronics arranged therein is substantially improved. This is because the cooling air for cooling the electronics is drawn in by means of the at least one intake pipe from a region of the area around the bottom box in which the temperature is significantly lower than in regions of the area around the bottom box which are closer to the bottom box. The aforementioned advantage is particularly pronounced in the preferred embodiment of this development, since in this development a direct and thus immediate operative connection of an intake pipe to a fan is possible so that the cooling air drawn in by means of this intake pipe can be conveyed directly and thus immediately into the aforementioned fan.

An advantageous development of the aforementioned development of the induction hob according to the invention provides that the intake pipe is designed in one piece. As a result, the intake pipe can be particularly simple to design and produce.

An embodiment of the induction hob according to the invention, which is an alternative to the last-mentioned embodiment, provides that the intake pipe is made up of two parts, wherein a first part of the intake pipe is connected directly to the bottom box and a second part of the intake pipe is designed as a separate part that can be connected to the first part of the intake pipe, preferably that the two parts of the intake pipe are designed to be clampable or latchable to one another. This allows for flexible use of the induction hob according to the invention equipped therewith. Depending on the requirements of the individual case, it is then possible to install the bottom box either having only the first part of the intake pipe, i.e., with a shortened intake pipe, or having the first and the second part of the intake pipe during installation of the induction hob according to the invention. A person skilled in the art will make the appropriate selection depending on the available installation space for the inductive induction hob according to the invention. For example, it would thus also be possible to adapt the height of the induction hob to the conditions on-site when installing an induction hob according to the invention, which is designed as an autonomous induction hob, on site, i.e., with the end customer.

Another advantageous development of the induction hob according to the invention provides that the induction hob has a plurality of fans arranged at a distance from one another for cooling the electronics, and that the bottom box comprises, at least on an outer side, an air guiding channel for homogenizing a temperature in an interior of the bottom box, wherein the air guiding channel is flow-connected, on one side by means of an air inlet opening of the air guiding channel to the interior of the bottom box and, on the other side, by means of at least one air outlet opening of the air guiding channel to an environment surrounding the bottom box, and wherein the air outlet opening is arranged at a distance from the air inlet opening such that a lower temperature than an induction hob not comprising the aforementioned air guiding channel is reached at the air inlet opening during enclosed test operation of the induction hob. Homogenization of the temperature in the bottom box can thereby be simple to design and produce. During the aforementioned enclosed test operation, for example for the North American market, the induction hob is enclosed in a completely airtight manner in such a way that the cooling air can only circulate within the enclosure. There is hence no air exchange with the free surroundings outside the enclosure. Without the aforementioned air guiding channel, it would not be possible to rule out very high temperatures in one of the fans with, at the same time, very moderate temperatures in the other fans due to the structural conditions of the induction hob according to the invention. This development provides a remedy here.

An advantageous development of the last-mentioned embodiment of the induction hob according to the invention provides that the air inlet opening is arranged directly adjacently to one of the fans or a heat sink operatively connected to said fan. In this way, it is possible, for example, to targetedly reduce, by means of the air guiding channel, very high temperatures reached at one of the fans in the absence of an air guiding channel to a lower temperature at said fan. Due to the structural conditions in the bottom box comprising the electronics housing installed therein and the associated fluidic differences between the individual fans of the plurality of fans, the example described above is quite realistic.

An advantageous development of the induction hob provides that the air guiding channel is formed by means of an outer side of the bottom box and an air guide plate fastened to said outer side of the bottom box. As a result, the air guiding channel can be particularly simple to design and produce.

Furthermore, a further advantageous development of the induction hob according to the invention provides that the aforementioned plates are each made of galvanized steel or aluminum. In this way, particularly advantageous materials are selected for the aforementioned plates for use in the induction hob according to the invention. The aforementioned plates, if present in the embodiment of the induction hob according to the invention, are specifically: the holding plate, the at least one intermediate plate, the bottom box, the at least one intake pipe and the air guide plate.

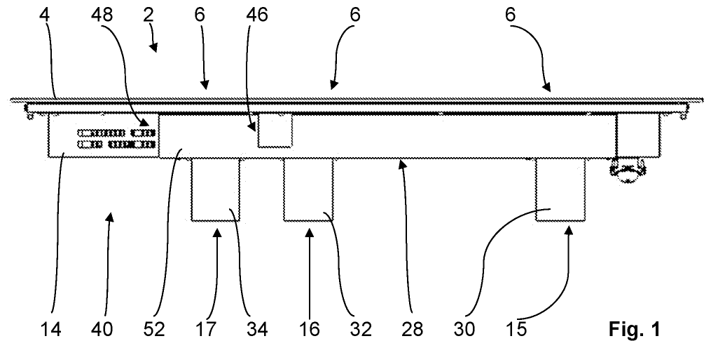

FIGS. 1 to 3 show an embodiment of the induction hob according to the invention purely by way of example.

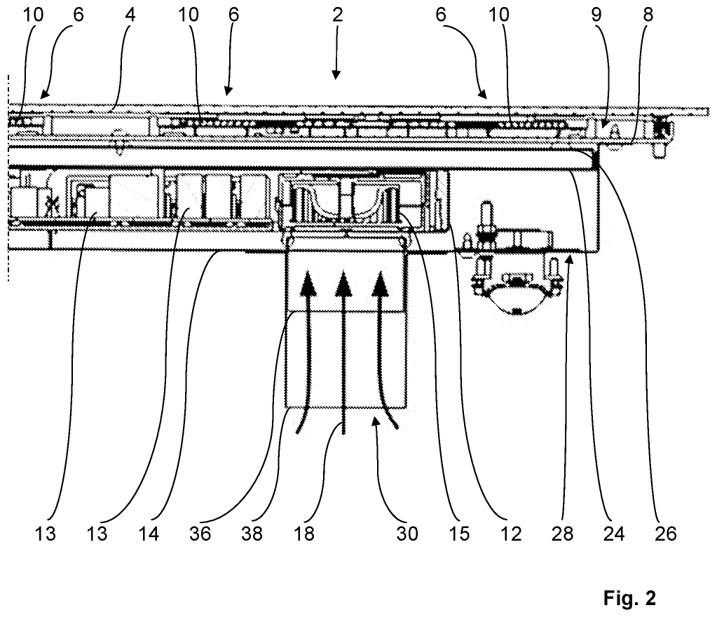

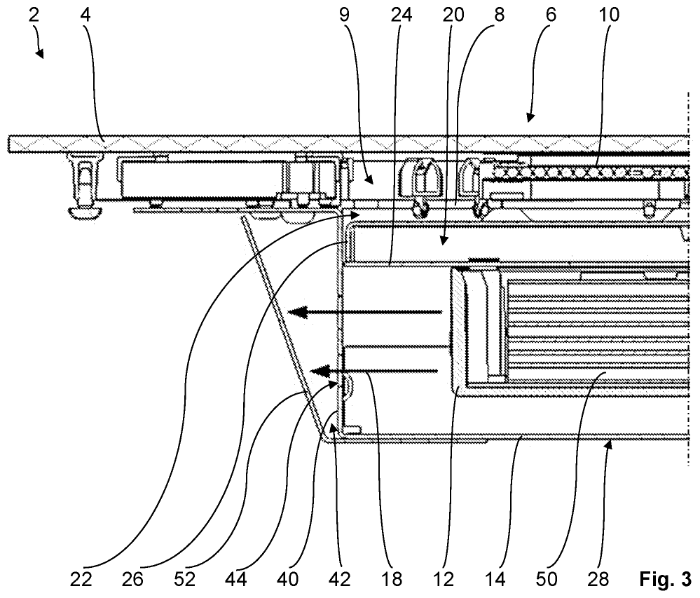

The induction hob 2 is designed for domestic use and comprises a top surface 4 designed as a glass ceramic surface and having a plurality of cooking zones 6, a holding plate 8, a plurality of inductive heating coils 10 arranged in an intermediate space 9 between the top surface 6 and the holding plate 8, at least one electronics housing 12 with electronics 13 for the heating coils 10, which electronics housing is arranged on a side of the holding plate 8 facing away from the heating coils 10, and a bottom box 14 which delimits the induction hob 2 at the bottom, wherein the electronics housing 12 comprising the electronics 13 is arranged in the bottom box 14 which is open at the top, and the holding plate 8 covers the bottom box 14 in a substantially airtight manner at the top, and wherein the induction hob 2 has a total of three fans 15, 16, 17 by means of which a cooling air flow for cooling the electronics 13 can be generated in the bottom box 14. In FIGS. 2 and 3, the cooling air flow is symbolized by arrows 18 filled in black. The cooling air flow can only be guided in the bottom box. In the present embodiment, however, the cooling air flow 18 is guided both in the bottom box 14 and in the electronics housing 12 arranged in the bottom box 14. As can be seen from FIG. 2, the fans 15, 16, 17 are arranged in the electronics housing 12. Although only fan 15 is explicitly shown in FIGS. 1 to 3, fans 16 and 17 are installed in an analogous manner in the electronics housing 12.

Dimensional stability of the holding plate 8 is very important for the function of the induction hob 2, since good contact of the inductive heating coils 10 with the top surface 4 of the induction hob 2 is required for sufficient inductive coupling between the inductive heating coils 10 of the induction hob 2, on the one hand, and induction cookware placed on one of the cooking zones 6 of the induction hob 2, on the other. Corresponding structural measures or components for ensuring dimensional stability of the holding plate 8 in each operating state of the induction hob 2 are known to a person skilled in the art. Depending on the requirements of the individual case, a person skilled in the art will make the corresponding selection of suitable measures in order to achieve dimensional stability of the holding plate 8.

The present induction hob 2 is designed to be suitable for the North American market, i.e., for the USA or Canada. Accordingly, the bottom box 14 has to be designed as a plastics drip tray. In case of fire, this plastics drip tray is intended to receive molten plastics so that it cannot flow out of the induction hob 2.

In order to improve temperature management in the induction hob 2, at least one air chamber, specifically two air chambers 20, 22, is/are arranged between the bottom box 14 comprising the electronics 13 on one side and the holding plate 8 on the other side, wherein the air chambers 20, 22 each extend in parallel with the holding plate 8 and substantially over the entire clear surface area of the bottom box 14 and are substantially hermetically sealed relative to a permeable remainder of the induction hob 2.

FIG. 1 shows the induction hob 2 in its installation position in a base cabinet of a piece of kitchen furniture.

In the present embodiment, the two air chambers 20, 22 are substantially hermetically sealed by means of two intermediate plates 24, 26, and additionally by means of the holding plate 8, from the permeable remainder of the induction hob 2. See in particular FIG. 3 in this regard.

As already stated, the at least one air chamber is designed as two air chambers 20, 22 which are separate from one another, wherein the two air chambers 20, 22 are arranged perpendicularly to the holding plate 8 in direct succession between the bottom box 14, on the one hand, and the holding plate 8, on the other hand, specifically such that the two air chambers 20, 22 are formed by means of the first intermediate plate 24 fastened to the bottom box 14, the second intermediate plate 26 which is folded on all edges and placed on the first intermediate plate 24, and the holding plate 8.

In the present embodiment, the bottom box 14 furthermore has at least one intake pipe, namely a total of three intake pipes 30, 32, 34 for ambient air, i.e., cooling air 18, on an underside 28 facing away from the holding plate 8, wherein each of the intake pipes 30, 32, 34 is assigned to one of the fans 15, 16, 17. See a combination of FIGS. 1 to 3 in this regard, wherein the intake pipes 32, 34 assigned to the fans 16 and 17 are shown only in FIG. 1. The respective positions of the fans 16 and 17 results, analogously to the position of fan 15 together with the intake pipe 30 assigned thereto, from the respective positions of the respective intake pipes 32, 34 in FIG. 1.

In principle, it is conceivable for the at least one intake pipe to be designed in one piece.

However, in the present embodiment, each of the three intake pipes 30, 32, 34 are designed in two parts, wherein a first part 36 of the relevant intake pipe 30, 32, 34 is directly connected to the bottom box 14 and a second part 38 of the relevant intake pipe 30, 32, 34 is designed as a separate part that can be connected to the first part 36 of the intake pipe 30, 32, 34, specifically such that the two parts 36, 38 of each of the three intake pipes 30, 32, 34, are designed to be clampable or latchable to one another. For this, see FIG. 2. In other embodiments of the invention, however, it is also conceivable for the two parts of the at least one intake pipe to be integrally bonded to one another in a suitable manner.

Fans 15, 16, 17 of the induction hob 2 are arranged at a distance from one another in the electronics housing 12. For the purpose of homogenizing a temperature in the bottom box 14 comprising the electronics housing 12 accommodating the electronics 13, the induction hob 2 has an air guiding channel 42 on an outer side 40 of the bottom box 14, which is designed as a front side, in order to homogenize the temperature in an interior of the bottom box 14, wherein the air guiding channel 42 is flow-connected, on the one hand, by means of an air inlet opening 44 of the air guiding channel 42 to the interior of the bottom box 14 and, on the other hand, by means of two air outlet openings 46, 48 of the air guiding channel 42 to the environment surrounding the bottom box 14, and wherein the air outlet openings 46, 48 are each arranged at a distance from the air inlet opening 44 such that a lower temperature than an induction hob 2 not comprising the aforementioned air guiding channel 42 is reached at the air inlet opening 44 during enclosed test operation of the induction hob 2. For this, see also the explanations relating thereto in the introduction to the description. Without the air guiding channel 42, a substantially higher temperature would be reached at the fan 15 compared with the two other fans 16, 17 during the aforementioned test operation. This temperature could be detrimental to the proper functioning of fan 15. Due to the existing air guiding channel 42, the cooling air 18 of fan 15 is now mixed with the cooling air 18 of the two other fans 16, 17 outside the bottom box 14 in the manner described in more detail below such that the cooling air 18 drawn in from the surroundings of the bottom box 14 by means of the intake pipe 30 and the fan 15 is significantly reduced compared with the hypothetical case of an induction hob according to the invention, which is structurally identical but does not comprise the above air guiding channel 42. Accordingly, proper functioning of the fan 15 is ensured even under extreme conditions such as those during a test operation. However, the associated increase in the temperatures at fans 16, 17 is unproblematic as regards the proper functioning of said fans 16, 17.

Here, the air inlet opening 44 is arranged directly adjacently to one of the fans, namely to fan 15, and a heat sink 50 which is operatively connected directly to said fan 15. The two other fans 16, 17 are also each operatively connected directly to a heat sink (not shown in FIGS. 1 to 3). The arrangement of the heat sinks, which are not operatively connected to fans 16, 17 in each case, is analogous to the arrangement of the heat sink 50 relative to fan 15. The air outlet openings 46, 48 are each arranged in the immediate vicinity of fans 16, 17 and the heat sinks operatively connected thereto. For this, see FIG. 1.

As can be seen in particular in FIG. 3, the air guiding channel 42 is, in the present embodiment, formed by means of the outer side 40 of the bottom box 14 and an air guide plate 52 fastened to said outer side 40 of the bottom box 14. For this purpose, the air guide plate 52 is folded several times so that the air guiding channel 42 formed in the aforementioned manner is substantially hermetically sealed except for the air inlet opening 44 and the two air outlet openings 46, 48.

Here, the aforementioned plates, namely the holding plate 8, the two intermediate plates 24, 26, the bottom box 14, the three intake pipes 30, 32, 34 and the air guide plate 52, are each made of galvanized steel or aluminum.

The mode of operation of the induction hob according to the present embodiment of the invention will be explained in more detail below with reference to FIGS. 1 to 3.

A user places the above-mentioned induction cookware comprising a food item to be heated on one of the cooking zones 6 of the induction hob 2 and switches the inductive heating coil 10 corresponding to said cooking zone 6 on in a manner known to a person skilled in the art by means of a hob control element.

As a result of the aforementioned activation of the induction hob 2, either some, or all, of the fans 15, 16, 17, for example, are automatically switched on by means of a controller of the induction hob 2 in order to cool the electronics 13 arranged in the electronics housing 12, for example generators for the inductive heating coils 10. The fans 15, 16, 17, provided they are each switched on, draw fresh air from the environment surrounding the bottom box 14 into the bottom box 14 by means of the intake pipes 30, 32, 34, and conduct this cooling air flow 18 through the electronics housing 12 which is flow-connected to the bottom box 14. The cooling air flow 18 thus flows, inter alia, through the heat sink 50, which comprises cooling fins and is operatively connected directly to fan 15. For this, see a combination of FIGS. 1 to 3 with the cooling air flow 18 indicated therein.

Downstream of the cooling air flow 18, the electronics housing 12 is also flow-connected to the bottom box 14 so that the cooling air flow 18 again flows from the electronics housing 12 into the bottom box 14 and from the bottom box 14 into the environment surrounding the bottom box 14, i.e., into the base cabinet.

Furthermore, air chambers 20, 22 here ensure effective thermal decoupling of the bottom box 14 comprising the electronics housing 12 accommodating the electronics 13, on the one hand, from the inductive heating coils 10 arranged above the holding plate 8, specifically on the holding plate 8, on the other hand. The bottom box 14 comprising the electronics housing 12 and the electronics 13 is thus thermally insulated from the inductive heating coils 10 without any additional thermal insulation measures, such as glass fiber insulation.

As already stated in the introduction to the description, due to the structural conditions in the bottom box 14 comprising the electronics housing 12 installed therein and due to the associated fluidic differences between the individual fans 15, 16, 17, very different temperatures may be reached in the bottom box, in particular at the individual fans 15, 16, 17. A substantially higher temperature may thus be reached at fan 15 than at the two other fans 16, 17, for example, when the air guiding channel 42 is not provided. Here, the air guiding channel 42 provides an effective solution in which the air guiding channel 42 mixes heated cooling air 18 directly from the fan 15 and the heat sink 50 operatively connected thereto through the air inlet opening 44, the air guiding channel 42 and the two air outlet openings 46, 48 arranged remotely from the air inlet opening 44 with, for example, the heated cooling air 18 from the two other fans 16, 17 and from the heat sinks operatively connected thereto outside the bottom box 14, for example during the above-mentioned test operation when the induction hob 2 is completely housed, so that cooling air 18 with a correspondingly lower temperature is drawn in by means of the intake pipe 30 assigned to fan 15. As already stated above, the associated increase in temperatures at the two other fans 16, 17 is unproblematic as regards proper functioning of said fans 16, 17. Of course, depending on the individual case at hand, it is necessary to position the air inlet opening and the at least one air outlet opening of the at least one air guiding channel in a corresponding manner so that, in case of a plurality of fans, the temperature of a fan that has a higher temperature load than the remaining fans without having an air guiding channel can be relieved in a targeted manner by means of the air guiding channel.

Due to the induction hob according to the present embodiment of the invention, temperature management in the induction hob 2 is thus substantially improved in a structurally simple manner, namely without complicated and thus expensive thermal insulation or cooling. This is true, in particular, because the induction hob 2 is an induction hob intended for the North American market, i.e., for the USA or Canada. Accordingly, the bottom box 14 has to be designed as a plastics drip tray. In case of fire, this plastics drip tray is intended to receive molten plastics so that it cannot flow out of the induction hob 2. Furthermore, the insulation used in the prior art, which is usually made of glass fiber materials and which is more difficult to handle during installation due to personnel safety measures, is effectively replaced by the two air chambers 20, 22.

The invention is not limited to the present embodiment. For example, the invention can also be advantageously used in induction hobs for commercial operation, i.e., for professional use. This also applies to induction hobs in which, unlike for the North American market, no special bottom box, namely no plastics drip tray, is required. In contrast to the present embodiment, embodiments of the invention are also conceivable in which only one air chamber and/or less than three fans or more than two air chambers and/or more than three fans is/are installed. The same applies to the number of intake pipes, if there are any. Furthermore, the at least one intake pipe, if there are any, can be designed as a one-piece intake pipe. In case of a multipart intake pipe, detachable or non-detachable connection techniques other than those mentioned by way of example in the present embodiment are also conceivable.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. An induction hob, comprising:
a top surface with at least one cooking zone;
a holding plate arranged in parallel with the top surface;
at least one inductive heating coil arranged in an intermediate space between the top surface and the holding plate;
at least one electronics housing with electronics for the heating coil, which electronics housing is arranged on a side of the holding plate facing away from the heating coil;
a bottom box delimiting the induction hob at the bottom, the electronics housing comprising the electronics being arranged in the bottom box, which is open at a top thereof, and the holding plate covering the bottom box in a substantially airtight manner at the top; and
at least one fan by which a cooling air flow for cooling the electronics is generatable in the bottom box,
wherein at least one air chamber is arranged between the bottom box comprising the electronics on one side and the holding plate on an other side, the at least one air chamber extending in parallel with the holding plate and substantially over an entire clear surface area of the bottom box and being substantially hermetically sealed relative to a permeable remainder of the induction hob.

2. The induction hob of claim 1, wherein the at least one air chamber is substantially hermetically sealed by at least one intermediate plate from the permeable remainder of the induction hob.

3. The induction hob of claim 1, wherein the at least one air chamber comprises two air chambers which are separate from one another.

4. The induction hob of claim 1, wherein the bottom box has at least one intake pipe for ambient air on an underside facing away from the holding plate.

5. The induction hob of claim 4, wherein the intake pipe comprises one piece.

6. The induction hob of claim 4, wherein the intake pipe comprises two parts, a first part of the intake pipe being directly connected to the bottom box, and a second part of the intake pipe comprising a separate part connectable to the first part of the intake pipe.

7. The induction hob of claim 1, further comprising:
a plurality of fans arranged at a distance from one another for cooling the electronics
wherein the bottom box has, at least on an outer side, an air guiding channel for homogenizing a temperature in an interior of the bottom box, the air guiding channel being flow-connected by an air inlet opening of the air guiding channel to the interior of the bottom box and by at least one air outlet opening of the air guiding channel to an environment surrounding the bottom box, and
wherein the air outlet opening is arranged at a distance from the air inlet opening such that a lower temperature than an induction hob without the air guiding channel is reached at the air inlet opening during enclosed test operation of the induction hob.

8. The induction hob of claim 7, wherein the air inlet opening is arranged directly adjacently to one fan of the plurality of fans or a heat sink operatively connected to one fan.

9. The induction hob of claim 7, wherein the air guiding channel is formed by an outer side of the bottom box and an air guide plate fastened to the outer side of the bottom box.

10. The induction hob of claim 9, wherein the holding plate, the bottom box, the at least one intermediate plate, the intake pipe, and the air guide plate each comprise galvanized steel or aluminum.

11. The induction hob of claim 2, wherein the at least one air chamber is substantially hermetically sealed from the permeable remainder of the induction hob by the holding plate.

12. The induction hob of claim 3, wherein the two air chambers are arranged perpendicularly to the holding plate in direct succession between the bottom box on one side and the holding plate on the other side.

13. The induction hob of claim 12, wherein the two air chambers are formed by a first intermediate plate fastened to the bottom box, a second intermediate plate, all edges of which are bent and which is placed on the first intermediate plate, and the holding plate.

14. The induction hob of claim 4, wherein the at least one intake pipe is assigned to a fan in each case.

15. The induction hob of claim 6, wherein the two parts of the intake pipe are clampable or latchable to one another.
